(19) United States
(12) Patent Application Publication
(10) Pub. No.: US 2008/0307135 A1
(43) Pub. Date: Dec. 11, 2008

(54) High performance programmable logic system interface and chip

(76) Inventors: Yi-Feng Jang, Taishan Township (TW); Zhi-Jian Liang, Shanghai (CN); Hai-Ping Liu, Shanghai (CN); Hai-Jun Shu, Shanghai (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 11/808,013

(22) Filed: Jun. 6, 2007

(51) Int. Cl. G06F 13/20

(52) U.S. Cl. 710/110

(57) ABSTRACT

A chip with a high performance programmable logic system interface, including a first internal device, a second internal device and a bus master, is provided. The first internal device, which is integrated into the chip, communicates with an external device by a first set of internal buses and a first set of external buses. The second internal device, which is integrated into the chip, communicates with the external device by a second set of internal buses and a second set of external buses. The bus master is configured to control the first set of internal buses, the first set of external buses, the second set of internal buses and the second set of external buses. The first internal device and the second internal device communicate with the bus master simultaneously.

### BACKGROUND OF THE INVENTION

(a) Field of the Invention

The present invention is related to a chip, and more particularly to a chip with high performance programmable logic system interface.

(b) Description of the Prior Art

Either parallel bus or serial bus data transmission may be selected for communication among IC chips depending on the application of the transmission system. When two chips are each provided with the parallel bus, a general purpose I/O (GPIO) interface is usually adapted to transmit signals. GPIO though providing advantage of allowing more flexibility, its operation speed is comparatively slower. Therefore, a parallel and programmable interface has been developed to put together the advantages of GPIO and serial bus.

A block chart illustrated in FIG. 1 of the accompanying drawings describes the transmission system. Wherein, a system 100 includes an IC chip 110 and an external device 120, which may be related to a printer, a video recorder, a digital camera, a storage device or any other computer peripheral device. The IC chip 110 includes an internal device 130 and a bus master 140. The internal device 130 may be related to a ping-pong First-In-First-Out (FIFO) device or a register. The IC chip 110 further includes a data bus 132, another data bas 122, an address bus 124, a master bus 136, another master bus 126, a ready bus 138, and another ready bus 128. The internal device 130 communicates with the external device 120 through those buses.

Each of both data buses 132, 122 is related to a 2-way bus provided that there is only one direction available for transmission at the same time; that is, at a given time, either read-out or write-in can be executed. The width respectively of the data bus 132 and the data bus 122 is programmable. For example, it is programmable so that at the same time the data of one byte or a word are transmitted. The address bus 124 operates for the external device 120 to transmit the address that is accessible to a memory or a register of the external device 120. Both master buses 136 and 126 transmit control signals to write in, read out or select the external device 120. Both of the ready buses 138 and 128 transmit handshake signals to respectively control signals from the internal device 130 and the external device 120 to the master bus 140. For example, if the external device 120 relates to a ping-pong FIFO device, both ready buses 138 and 128 transmit full/empty signals.

Whereas either data bus 132 or 122 as illustrated in FIG. 1 relates to is half duplex, the operating mode of the system 100 may be divided into data write in mode and data readout mode. In data write in mode (i.e., data are written in from the internal device 130 and transmitted to the external device 120), the data bus 132 transmits signals from the internal device 130 to the master bus 140 and the data bus 122 transmits signals from the master bus 140 to the external device 120. In the data readout mode (i.e., the internal device 130 reads out data from the external device 120), the data bus 122 transmits signals from the external device 120 to the master bus 140, and the data bus 133 transmits signals from the master bus 140 to the internal device 130.

As illustrated in FIG. 2 for waveforms of bus transmission signals, a bus transmission cycle has eight statuses comprised of one status of idle and seven transmission statuses. In the idle status, all buses are disabled; and in the transmission statue, programmable data, address, and master bus can be distinguished. Judging from FIG. 2, data can be transmitted in a unilateral direction at a given time to prevent simultaneous readout and write in.

Therefore, the system warrants a total duplex bus to provide a mechanism for receiving and transmitting data at the same time.

### SUMMARY OF THE INVENTION

The primary purpose of the present invention is to provide a high performance programmable logic system interface to execute two-way and simultaneous transmission.

On one aspect, the present invention provides a chip with the high performance programmable logic system interface including a first internal device, a second internal device, and a master bus. Wherein, the first internal device disposed in the chip communicates with the external device through a first set of internal bus and a first set of external bus. The second internal device is also located in the chip to communicate with the external device through a second set of internal bus and a second set of external bus. The master bus controls the first set of internal bus, the first set of external bus, the second set of internal bus, and the second set of external bus. Wherein, both of the first and the second internal devices communicate with the master bus at the same time.

On another aspect, the present invention provides a high performance programmable logic system interface received in a chip; and the chip includes a first internal device, a second internal device, and a master bus. Wherein, the high performance programmable logic system interface includes a first set of internal bus to communicate with the first internal device and the master bus, a first set of external bus to communicate with the master bus and an external device, a second set of internal bus to communicate with the second internal device and the master bus, and a second set of external bus to communicate with the master bus and the external device. Wherein, both of the first and the second internal devices simultaneously communicate with master bus.

### BRIEF DESCRIPTION OF THE DRAWINGS

FIG. 1 is a block chart showing a data transmission system of the prior art;

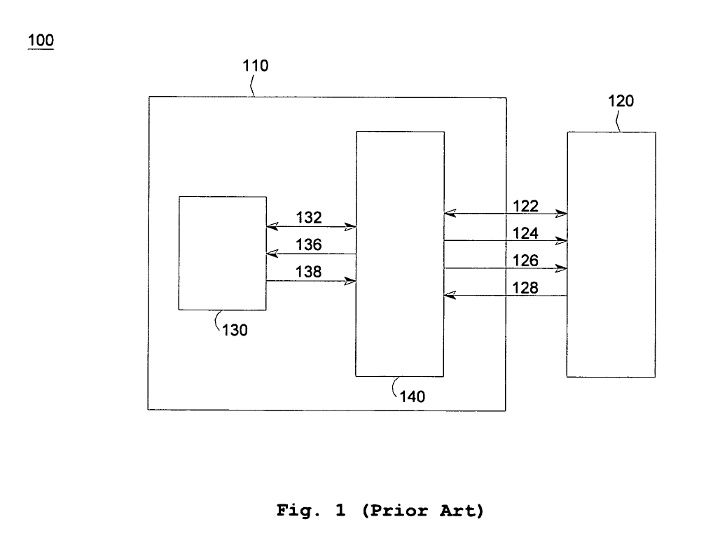

FIG. 2 is a schematic view showing an example of waveforms of bus transmission signals of the prior art;

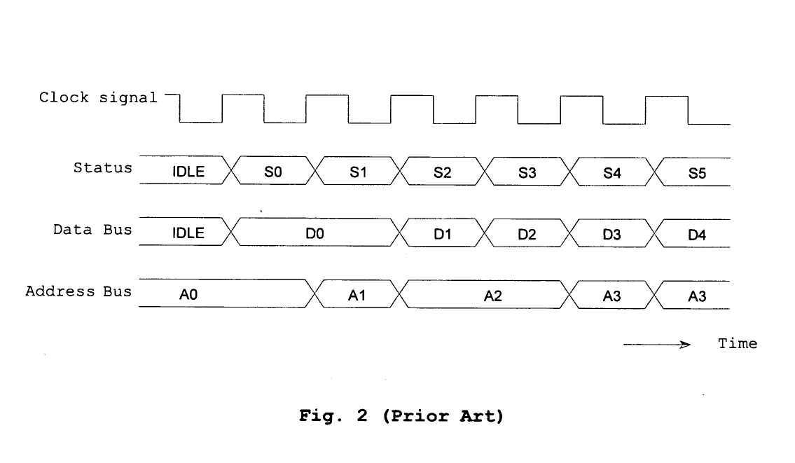

FIG. 3 is a block chart showing a data transmission system of a preferred embodiment of the present invention;

FIG. 4 is a block chart showing a data transmission system in a first-in-first-out transaction mode of another preferred embodiment of the present invention.

FIG. 5 is a block chart showing a data transmission system in a micro-control unit (MCU) transaction mode of another preferred embodiment yet of the present invention;

FIG. 6 is a time sequence view of the bus transmission signals based on the preferred embodiment illustrated in FIG. 4; and

FIG. 7 is a time sequence view of the bus transmission signals based on the preferred embodiment illustrated in FIG. 5.

### DETAILED DESCRIPTION OF THE PREFERRED EMBODIMENTS

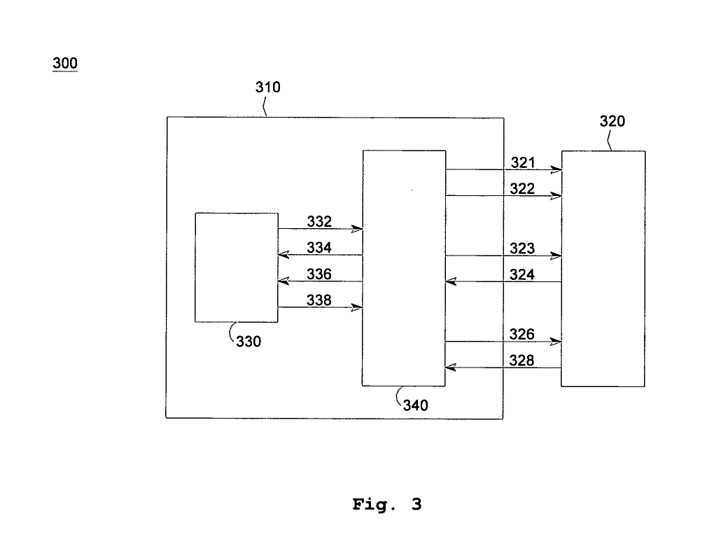

The present invention discloses a high performance programmable system interface and system and can be better understood by referring to the following description in conjunction with FIGS. 3 through 7 of the accompanying drawings. However it is to be noted that those devices, systems, and procedural steps described in the preferred embodiments are only for describing the present invention, not to limit the scope of the prevent invention.

Referring to FIG. 3 for a data transmission system 300 of a preferred embodiment of the present invention is illustrated. The system 300 includes an IC chip 310 and an external device 320. Wherein, the external device 320 may be related to a printer, a video-recorder, a digital cameral, a storage device or other computer peripheral device. The IC chip 310 includes an internal device 330 and a master bus 340. The internal device 330 may be related to a ping-pong first-in-first-out (FIFO) device or a register. The IC chip 310 further includes two data buses 332, 334 and a master bus 336 to communicate with the internal device 330 and the master bus 340. An optional ready bus 338 may be disposed at where between the internal device 330 and the master bus 340 to transmit handshake signals for control data transmission between the internal device 330 and the master bus 340. In addition, the IC chip 310 further includes two buses 322 and 325, two address buses 321 and 323, a master bus 326, and a ready bus 328 to communicate with the external device 320 and the master bus 340. The ready bus 328 operates to transmit handshake signals for controlling signals transmitted from the external device 320 to the master bus 340. The width of any of those buses referred above is programmable, e.g., programmed to transmit signals of a byte or a word at the same time. The internal device 320 contains multiple, and two in the preferred embodiment, storage units in the form of a register or a memory. Those two storage units are respectively assigned to write into and read out from the external device. Therefore, both of the internal device 320 and the outer device 320 may communicate with the master bus 340 at the same time. When further added with two data buses 322 and 324 as well as two address buses 321 and 323 located between the master bus 340 and the external device 320, both of the internal device 330 and the external device 320 may simultaneously execute readout and write in from and to the external device 320 to achieve the purpose of full duplex.

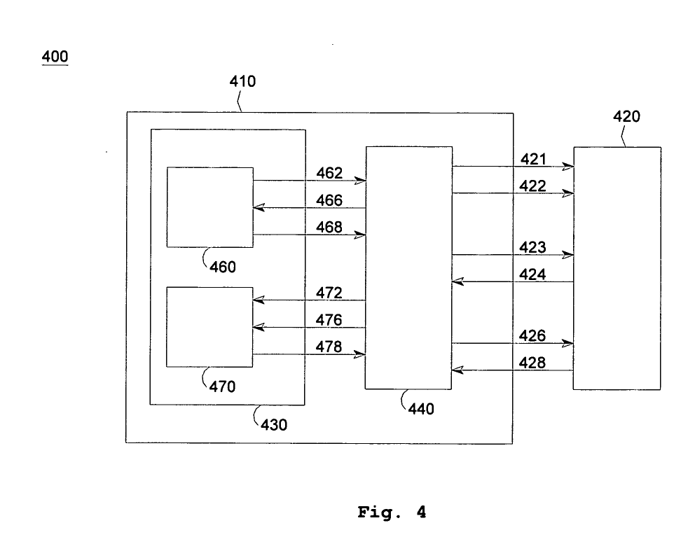

FIG. 4 shows another preferred embodiment of the present invention for a data transmission system 400 operating in the FIFO mode. The system 400 includes an IC chip 410 and an external device 420. The IC Chip 410 includes an internal device 430 and a master bus 440, wherein the internal device contains a first ping-pong FIFO device 460 and a second ping-pong FIFO device 470. The first ping-pong FIFO device 460 and the master bus 440 communicate with other by means of a data bus 462, a master bus 466, and a ready bus 468. The second ping-pong FIFO device 470 and the master bus 440 communicate with each other by means of a data bus 472, a master bus 476, and a read bus 478. Furthermore, the external device 420 and the master bus 440 communicate with each other by means of two data buses 422 and 424, two address buses 421 and 423, a master bus 426, and a ready bus 428. Wherein, both data buses 422 and 424 are different from each other and can be separately controlled; both address buses 421 and 423 are also different from each other and can be separately controlled. Given with two sets of data and address buses independent from each other and the first ping-pong FIFO device 460 and the second ping-pong FIFO device 470 respectively assigned to transmit and receive data, the internal device 430 may simultaneously read from and write in to the external device 420 thus to achieve the purpose of full duplex.

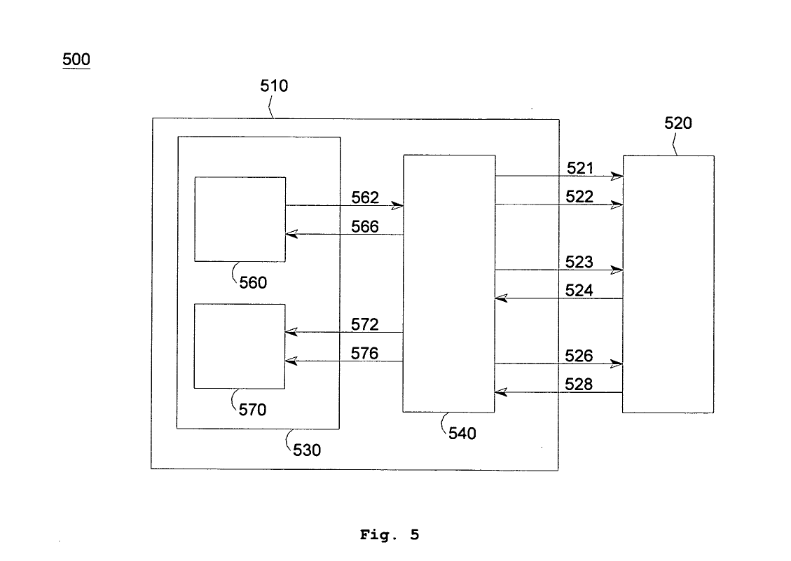

In another preferred embodiment yet of the present invention as illustrated in FIG. 5, a data transmission system 500 of a micro-control unit transaction mode includes an IC chip 510 and an external device 520. The IC chip 510 contains an internal device 530 and a master bus 540, wherein the internal device 530 relates to a micro-control unit (MCU) containing a first register 560 and a second register 570. The first register 560 and the master bus 540 communicate with each other by means of a data bus 562 and a master bus 566, while the second register 570 and the master bus 540 communicate with each other through a data bus 572 and a master bus 576. Both of the external device 520 and the master bus 540 communicate with each other through two data bus 522 and 524, two address buses 521 and 523, a master bus 526, and a ready bus 528. The external device 520 and the master bus 540 communicate with each other by means of two data buses 522 and 524, two address buses 521 and 523, a master bus 526, and a ready bus 528. Wherein, both data buses 522 and 524 are different from each other and can be separately controlled; both address buses 521 and 523 are also different from each other and can be separately controlled. Given with two sets of data and address buses and both of the first register 560 and the second register 570 respectively assigned to transmit and receive, the internal device 530 may simultaneously execute read out from and write into the external device 520.

The internal device 530 may include all units adapted to the MCU, e.g., ROM, RAM, CPU, I/O port, and timer of the prior art, which will not be elaborated herein.

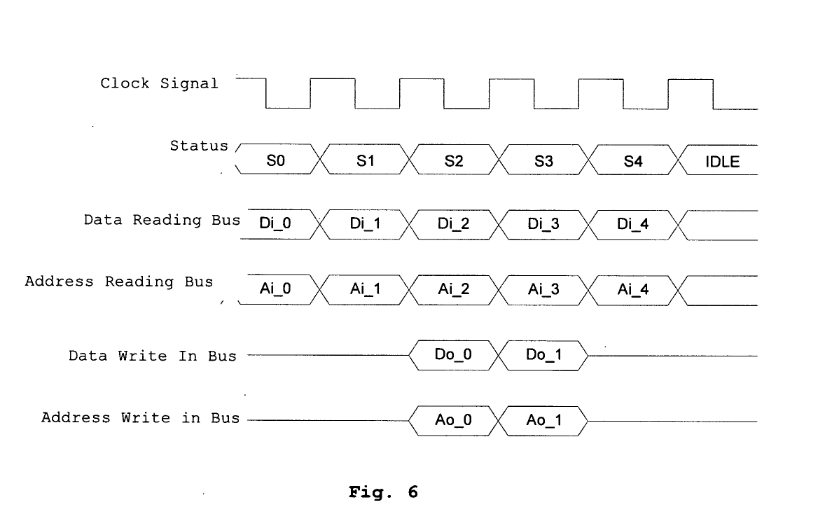

FIG. 6 shows a time sequence of bus transmission signals for the preferred embodiment illustrated in FIG. 4. The bus transmission process may be divided into idle status and transmission status. All buses are disabled in idle status. Waveforms respective for Statuses S0, S1, and S2 are determined according to a firmware pre-stored in the internal device. With two sets of independent address bus and data bus, a lot of data is be written in and transmitted at the same time when another lot of data is read out and received. For example, in status S2, at the same time Data Do_0 (Address Ao_0) are written in and transmitted, another data Di_2 (Address Ai_2) are read out and received.

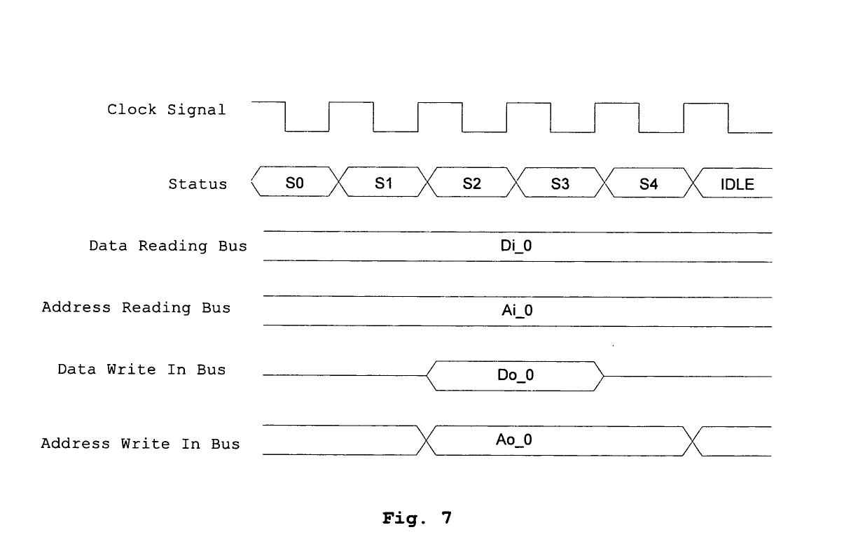

FIG. 7 shows a time sequence of bus transmission signals for the preferred embodiment illustrated in FIG. 5. Statuses S0 and S1 read only without writing in data, and Statuses S2 and S3 read out also write in data through the control by firmware. As illustrated in FIGS. 6 and 7, the present invention is a high performance programmable logic system interface that allows reading out data from external device for transmission to internal device, and writing in data from internal device and transmission to external device simultaneously.

The chip referred in the present invention may be related to a USB chip. The regular USB chip usually contains multiple FIFO devices, two in most cases, to store certain setup data. Therefore, one FIFO device is used to read out and another FIFO is used to write in without requiring additional HW.

The master bus in the present invention may be related to an I2S (Inter-IC Sound) master bus for both of a microphone and a loudspeaker to function at the same time. Whereas the present invention provides duplex bus, data transmitted from a microphone and data transmitted from a loudspeaker can be transmitted at the same time.

The present invention may be applied in a digital camera to allow a video sensor to retrieve videos and a loudspeaker to play sound effects through the full duplex bus of the present invention.

It is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

What claim is:

1. A chip with high performance programmable logic system interface including a first internal device received in the chip and communicating with an external device by means of a first set of internal bus and a first set of external bus; a second internal device also received in the chip and communicating with the external device by means of a second set of internal bus and a second set of external bus; and a master bus to control the first set of internal bus, the first set of the external bus, the second set of internal bus, and the second set of the external bus; and the first internal device and the second internal device simultaneously communicate with the master bus.

2. The chip as claimed in claim 1, wherein the first and the second internal devices are respectively related to a ping-pong first-in-first-out (FIFO) device.

3. The chip as claimed in claim 1, wherein the first and the second internal device are respectively related to a micro-control unit (MCU) register.

4. The chip as claimed in claim 1, wherein the first set of internal bus connects the first internal device and the master bus; and the first set of internal bus includes a data bus and a master bus.

5. The chip as claimed in claim 1, wherein the first set of external bus connects the external device and the master bus; and the first set of external bus includes a data bus and address bus.

6. The chip as claimed in claim 1, wherein the first internal device and the second internal device simultaneously communicate with the external device.

7. The chip as claimed in claim 1, wherein the external device is related to a printer, a video recorder, a digital camera, a storage device or other computer peripheral device.

8. The chip as claimed in claim 1, wherein the chip further includes an external master bus to communicate the external device and the master bus.

9. The chip as claimed in claim 1, wherein the width of each bus is programmable.

10. The chip as claimed in claim 1, wherein the master bus relates to an I2S (Inter-IC Sound) master bus to provide full-duplex transmission between a microphone and a loudspeaker.

11. A high performance programmable logic system interface contained in a chip, the chip including a first internal device, a second internal device, and a master bus; the high performance programmable logic system interface comprising a first set of internal bus to communicate the first internal device and the master bus; a first set of external bus to communicate the master bus and an external device; a second set internal bus to communicate with the second internal device and the master bus; and a second set of external bus to communicate the master bus and the external device; and the first internal device and the second internal device simultaneously communicate with the master bus.

12. The high performance programmable logic system interface as claimed in claim 11, wherein the first and the second internal devices are respectively related to a ping-pong FIFO device.

13. The high performance programmable logic system interface as claimed in claim 11, wherein the first and the second internal devices are respectively related to a micro-control unit (MCU) register.

14. The high performance programmable logic system interface as claimed in claim 11, wherein the first set of internal bus includes a data bus and a master bus.

15. The high performance programmable logic system interface as claimed in claim 11, wherein the first set of external bus includes a data bus and an address bus.

16. The high performance programmable logic system interface as claimed in claim 11, wherein the first internal device and the second internal device simultaneously communicate with the external device.

17. The high performance programmable logic system interface as claimed in claim 11, wherein the external device is related to a printer, a video recorder, a digital camera, a storage device or other computer peripheral device.

18. The high performance programmable logic system interface as claimed in claim 11, wherein the interface further includes an external master bus to communicate the external device and the master bus.

19. The high performance programmable logic system interface as claimed in claim 11, wherein the width of each bus is programmable.

20. The high performance programmable logic system interface as claimed in claim 11, wherein the master bus relates to an I2S (Inter-IC Sound) master bus to provide full-duplex transmission between a microphone and a loudspeaker.
